(19) United States
(12) Patent Application Publication
(10) Pub. No.: US 2011/0274307 A1
(43) Pub. Date: Nov. 10, 2011

(54) PORTABLE AMPLIFIED AUDIO SYSTEM FOR MOTORIZED VEHICLES

(76) Inventor: David W. Lynch, Yulee, FL (US)

(21) Appl. No.: 12/775,431

(22) Filed: May 6, 2010

(51) Int. Cl. H04R 1/02

(52) U.S. Cl. 381/389

(57) ABSTRACT

A portable amplified audio system for a motorcycle removably mounts on motorcycles, interfaces with a wide range of audio output devices, is easy to remove and install, includes a cover for protecting components from the elements, is oriented toward a rider on the motorcycle to facilitate superior acoustics and safe operation and does not depend upon a particular helmet or type of motorcycle. The system includes a housing having an open receptacle defining a compartment with an open top for receiving and supporting a portable audio device. An audio amplifier contained in the housing generates amplified audio output signals from the audio output signals from the portable audio device. The amplified output signals are played through at least one loudspeaker. An electric power inlet, plug and cable are releasably connect the system to the motorcycle's battery. A tank bag with sound emitting and ventilating openings in a top panel is provided to contain the housing and secure the system to a fuel tank. An access panel is provided in the bag for electrical connection. An optional battery drain limitation circuit interrupts electrical power supplied from the battery if voltage drops below a determined level. An optional volume regulation circuit reduces volume if ambient noise levels are low.

### FIELD OF THE INVENTION

This invention generally relates to audio players, and more particularly, to an amplified audio docking station configured for removable mounting on an actual or false motorcycle fuel tank.

### BACKGROUND

Many motorcycle audio systems require permanent, bulky brackets to mount a stereo on the handlebars. Such mounting can compromise handling, exposes the unit to the elements, and is not readily adaptable to sportier vehicles and vehicles with minimal vacant handlebar space.

Other motorcycle audio systems are permanently installed in the fairings of large motorcycles. Disadvantageously, such configurations are costly and permanently expose the system to the elements and thieves.

Helmet-mounted systems have also been devised. Such systems are effective for emitting audio in close proximity to the wearer's ears. Unfortunately, however, the audio components add weight to the helmet and can cause discomfort to the wearer. Additionally, in the event of a sudden blow to the helmet the components tend to fail. Furthermore, such systems only work with modified, over-the-ear helmets, which many rider's dislike. Such a system, of course, is ineffective if a motorcyclist rides with a less-than-over-the-ear helmet or rides without a helmet. Moreover, helmet-mounted systems often have a wire that leads from a personal music device to the helmet. Such a setup is cumbersome and may be dangerous in the event of a collision.

What is needed is a new and improved motorcycle audio system for removable mounting on motorcycles. The system should interface with a wide range of existing audio output devices, such as a digital media player (e.g., Apple i-Pod®), a portable radio, a compact disc player, a tape player, or any other portable audio output device that includes an audio output interface, whether now known or hereafter developed. The system should not interfere with steering. The system should be easy to remove and install. The system should include a cover for protecting components from the elements. The system should be oriented toward a rider on the motorcycle to facilitate superior acoustics and safe operation. The system should not depend upon a particular helmet or type of motorcycle.

The invention is directed to overcoming one or more of the problems and solving one or more of the needs as set forth above.

### SUMMARY OF THE INVENTION

To solve one or more of the problems set forth above, in an exemplary implementation of the invention, a portable amplified audio system for a motorcycle is provided. The system removably mounts on motorcycles, interfaces with a wide range of audio output devices, is easy to remove and install, includes a cover for protecting components from the elements, is oriented toward a rider on the motorcycle to facilitate superior acoustics and safe operation and does not depend upon a particular helmet or type of motorcycle.

In one exemplary embodiment, a portable amplified audio system for a motorcycle having a battery includes a housing having an open receptacle includes a compartment in the housing with an open top for receiving and supporting a portable audio device. Optionally, the compartment may have a cushioning layer. An audio amplifier is contained in the housing. The audio amplifier has an audio input interface, an audio output interface and a power supply interface. A device interface such as a jack and cable connects the amplifier audio input interface to the portable audio device and communicate audio output signals from the portable audio device to the audio input interface of the amplifier. The amplifier is configured to generate amplified audio output signals from the audio output signals from the portable audio device. At least one loudspeaker is attached to the housing and operably coupled to the audio output interface of the amplifier. The loudspeakers receive amplified audio output signals from the amplifier through the output interface and produce audible sounds based upon the amplified audio output signals. An electric power inlet receives electrical power from the battery. The housing includes a removable cover attached to a base. The system is configured to be contained within a motorcycle tank bag, such as a conventional motorcycle tank bag or a motorcycle tank bag specially configured for use with the system as discussed herein.

The system has many accessories and options. For example, the system may include a protective grille covering each loudspeaker. The system may also include a power switch mounted to the housing and electrically coupled between the electric power inlet and the amplifier and configured to control electrical power supplied from the electric power inlet. The system may further include a volume control mounted to the housing, operably coupled to each loudspeaker and configured to adjust the volume of each loudspeaker. An optional power outlet (e.g., a cigarette lighter outlet) may be configured to supply electrical power to a compatible plug, which may be electrically coupled to any compatible electrical appliance. Each loudspeaker may optionally be weather resistant.

In another aspect of the exemplary embodiment, a polarized electric plug removably mates with the electric power inlet. A power cable with a pair of electrically conductive wires is coupled to the plug and to terminals of the battery of the motorcycle. A removable plug cover is configured to cover a portion of the plug with any exposed positive and negative terminals. The plug cover may be tethered to the system. The plug cover may include a permanent magnet configured to releasably connect the plug cover to an adjacent attracted metal component of the motorcycle.

In another aspect of the exemplary embodiment, a battery drain limitation circuit is electrically coupled to the electric power inlet and configured to monitor voltage and interrupt electrical power supplied from the battery through the electric power inlet if the battery voltage drops below a determined voltage. The battery drain limitation circuit may include a microcontroller configured to monitor battery voltage and a relay operably coupled to the microcontroller and configured to interrupt electrical power supplied from the battery through the electric power inlet if the battery voltage drops below a determined voltage.

In yet another embodiment, the system includes an automatic volume control that detects ambient (e.g., wind, engine and traffic) noise (e.g., in decibels) and automatically reduces volume if the volume setting is greater than a threshold setting and/or the ambient noise is less than a threshold value.

In yet another exemplary embodiment, a radio communication module may be configured to communicate output signals from the portable audio device to a compatible wireless headset and/or receive audio signals from a portable audio device for amplification and output. Such a module may be a wireless Bluetooth module.

In yet another embodiment, the system includes a motorcycle tank bag for containing the housing and having means for attachment to a motorcycle fuel tank. Such means may include flaps with magnets or straps. A top panel of the bag has openings in alignment with each loudspeaker and through which sound may be transmitted from each loudspeaker. An opening may be provided in alignment with a volume control, through which the volume control may be adjusted. An opening may also be provided in alignment with a power switch, through which the power switch may be adjusted. The motorcycle tank bag may further include a removable waterproof rain cover configured to cover the top panel. Additionally, a side access panel may be provided to allow passage of a power cable to supply electrical power to the system.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of an exemplary portable amplified audio system for a motorcycle according to principles of the invention; and

FIG. 2 is a perspective view of an exemplary opened portable amplified audio system for a motorcycle according to principles of the invention; and

FIG. 3 is a perspective view of an exemplary motorcycle tank bag for containing a portable amplified audio system according to principles of the invention and an optional cover; and

FIG. 4 is a perspective view of an exemplary motorcycle with an unsecured tank bag for containing a portable amplified audio system according to principles of the invention;

FIG. 5 is a schematic of components of an exemplary portable amplified audio system according to principles of the invention;

FIG. 6 is an alternative schematic of components of an exemplary portable amplified audio system according to principles of the invention;

FIG. 7 is a perspective view of an exemplary housing for an exemplary portable amplified audio system for a motorcycle according to principles of the invention;

FIG. 8 is a perspective view of a section of an exemplary housing for an exemplary portable amplified audio system for a motorcycle according to principles of the invention;

FIG. 9 is a perspective view of another portable amplified audio system for a motorcycle according to principles of the invention;

FIG. 10 is a flowchart of an exemplary method of preventing excessive drain on a battery according to principles of the invention;

FIG. 11 is a flowchart of an exemplary method of preventing excessive volume according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes, ornamental aspects or proportions shown in the figures.

### DETAILED DESCRIPTION

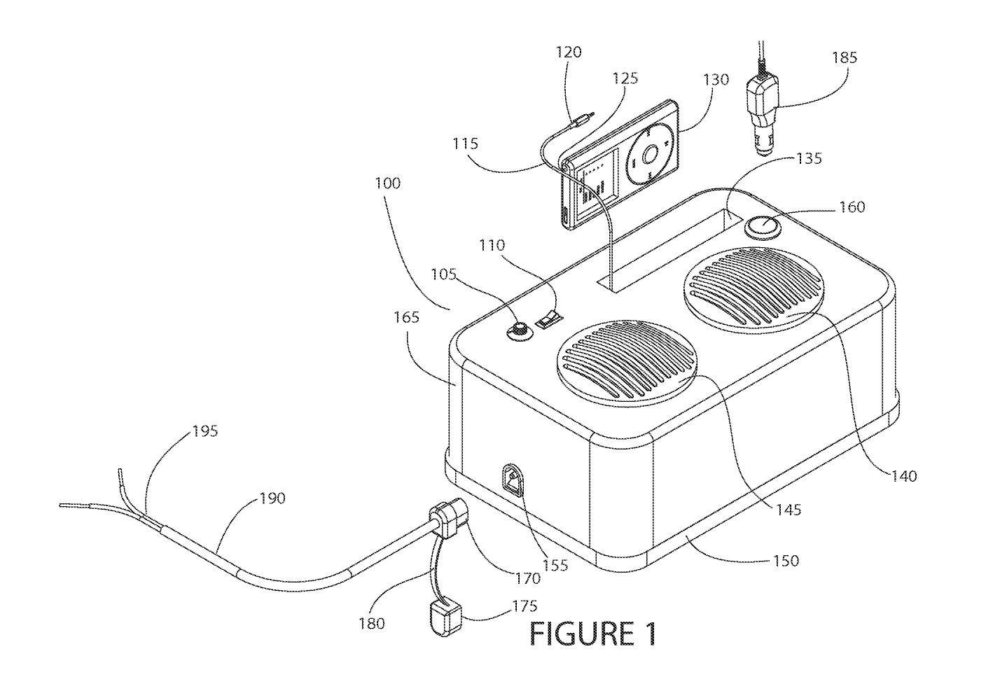

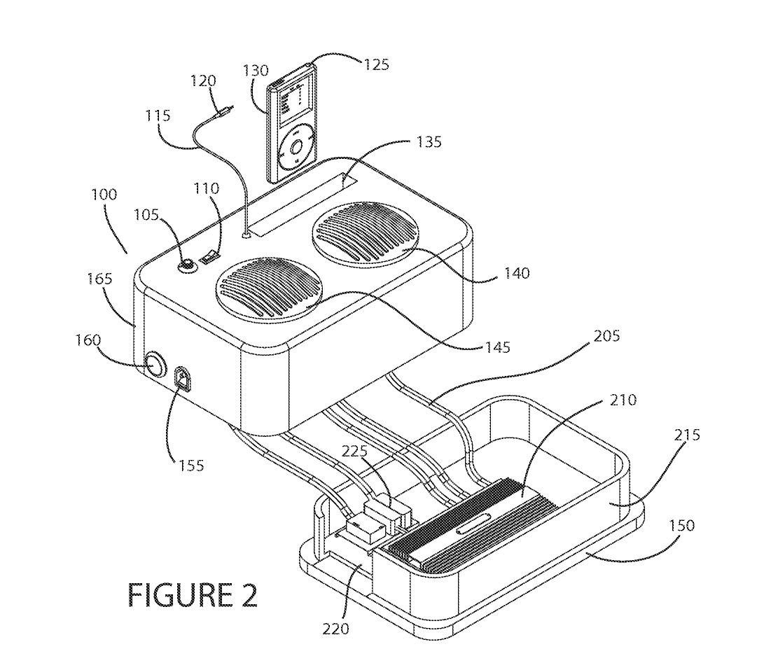

Referring to the Figures, in which like parts are indicated with the same reference numerals, various views of an exemplary portable amplified audio system 100 for a motorcycle (the “system”) according to principles of the invention are shown. With reference to FIG. 1, the system 100 includes a removable cover 165 mounted to a base 150. The cover 165 and base 150 form an enclosure and support structure for electronic components. The base 150 includes a sidewall 215 with an access slot 220 for a power inlet 155 (FIG. 2). The system 110 is configured for mounting in a tank bag on a motorcycle.

As used herein, fuel tank broadly refers to an actual fuel tank, i.e., a receptacle for storing fuel, as well as to a false, fake or simulated fuel tank, i.e., an ornamental feature that resembles an actual fuel tank.

The cover 165 includes a receptacle 135 for receiving a portable audio device 130. The portable audio device 130 may be placed in the receptacle 135. As shown in FIGS. 1 and 2, the receptacle 135 includes an opened top to receive the portable audio device 130. The receptacle 135 is sized to receive a conventional portable audio player 130. Optionally, an elastomeric cushioning sheet (e.g., Neoprene) is adhered with adhesive to the plastic interior of the receptacle to gently cradle and protect the audio device 130. An audio interface jack 120 operably connects the portable audio device 130 to the system 100. In an exemplary embodiment, the portable audio device is a handheld digital media player 130 or any other suitable portable audio player device with an audio output port 125. A system according to principles of the invention is compatible with most existing portable audio devices.

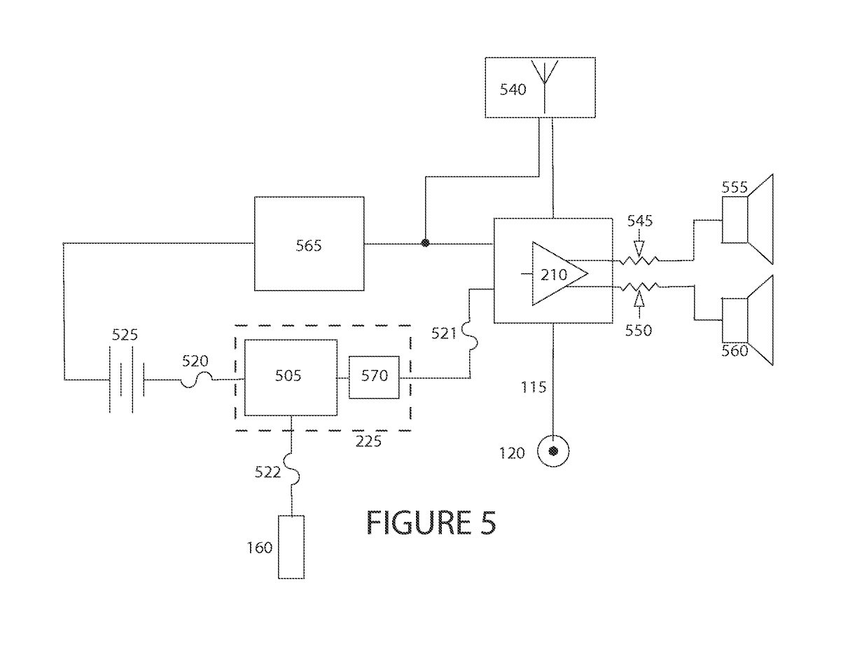

As shown in FIG. 2, the assembled cover 165 and base 150 define an interior compartment that houses electronic components of the system 100. The housed electronic components include an amplifier 210 and a battery isolator 225. The amplifier is an electronic audio amplifier that amplifies low-power audio signals emitted from the output port 125 of the portable audio device 130 through the connected audio interface jack 120 and cable 115, which is connected to an input port of the amplifier. The amplifier includes one or more output ports through which amplified signals may be supplied to one or more speakers 555, 560. The amplifier amplifies the low-power audio signals to a level suitable for driving speakers 555, 560 (FIG. 5), which are mounted to the cover 165 below protective speaker grilles 140, 145.

The system 100 receives electrical power from a motorcycle battery through a detachable electrical connection to facilitate installation and removal. In an exemplary embodiment, a polarized female power receptacle 155 receives a male plug 170 operably coupled to an electrical cable 190 with separately insulated wires 195 for electrically coupling to the positive and negative terminal terminals of the battery. When the plug 170 is inserted into the power receptacle 155 and the wires are electrically coupled to a battery, electrical power is supplied to the system 100. In a preferred embodiment, the plug 170 includes a tethered 180 removable cover 175, which may be placed over the male plug 170 when the system 100 is not installed on a motorcycle. Thus, the plug 170 is protected and insulated while the cable 190 is electrically coupled to the battery. The plug 170 and or cover 175 may include one or more magnets and/or clips for securing it to the motorcycle. A magnetic tank bag embodiment includes padded flaps containing relatively strong magnets to secure the bag to magnetically attracted elements (e.g., a fuel tank) of the motorcycle.

Electrical power is supplied to the amplifier 210 from the motorcycle battery, through a switch 110 electrically coupled to a battery isolator 225. In a preferred embodiment, the switch 110 is an illuminated on-off rocker switch 110 that controls the supply of electrical power to the battery isolator 225 and electrical components. The battery isolator 225 is a battery drain limitation circuit configured to monitor input voltage and interrupt (i.e., block) electrical power supplied from the battery if the battery voltage drops below a determined voltage. If the battery voltage equals or exceeds the determined voltage, the battery drain limitation circuit allows electrical power to be supplied from the battery to the system loads, such as the amplifier 210, illuminated rocker switch 110 and a power outlet 160. Battery voltage may be monitored with a microcontroller or discrete circuit elements while isolation may be accomplished with a relay, a high current diode and/or a zener diode having a breakdown voltage below the determined minimum voltage. Thus, the battery isolator 225 disables the system 100 if necessary to prevent excessive draining of the battery.

A car cigarette lighter socket (i.e., outlet or receptacle) 160 or car adapter is provided. While the socket 160 is shown on the top of the unit, it may be located in other places on the unit without departing from the scope of the invention. The socket 160 on top conveniently lines up with cords for radar detectors and GPS units. The socket 160 provides a conduit for supplying electrical power to accessories through a compatible plug 185. Such sockets and mating plugs are defined in the ANSI/SAE J563 specification. By way of example and not limitation such plugs 185 may be used to supply power to electric razors, portable spotlights, laptop computers, mobile phones, PDAs, USB adapters, digital audio players, lamps, thermoelectric coolers and countless other compatible accessories.

The system 100 includes at least one audio loudspeaker (“speakers”), such as the pair of speakers 555, 560 preferably below protective speaker grilles 140, 145, as conceptually illustrated in the FIGS. 1, 2 and 5. The speakers 555, 560 are conventional audio speakers configured to emit audible sounds in response to input electronic signals. In a preferred embodiment, weather resistant speakers are used; although the invention is not limited to such speakers. The speakers 555, 560 project the sound to the rider. Optionally, the speakers may be actively controlled with an electronic processor that automatically adjusts crossover and equalization settings and protects the speakers. The speakers 555, 560 have a power rating (in watts) which is compatible with that of the amplifier 210.

Optionally, a volume control 105 (i.e., as supplemental volume control) is provided to regulate the volume of audible output from the speakers 555, 560. The volume control is operably coupled to a potentiometer 545, 550 (FIG. 5) for each speaker 555, 560. Thus a user may easily adjust the output volume without adjusting settings on the portable audio device 130. Alternatively, volume controls of the device 130 may be used, in addition to or in lieu of volume control 105. Volume control 105 is an optional feature.

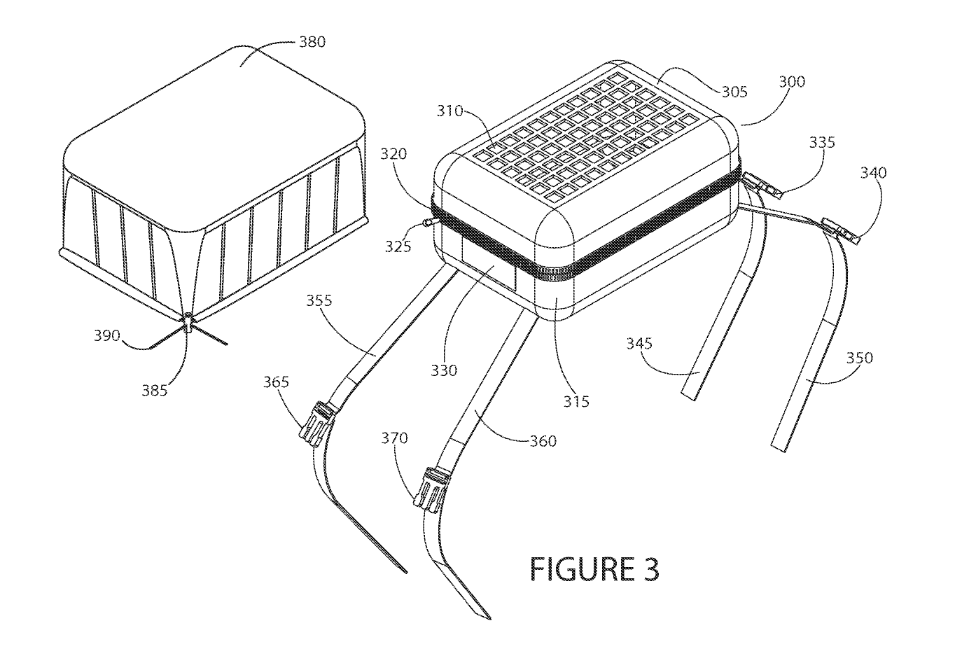

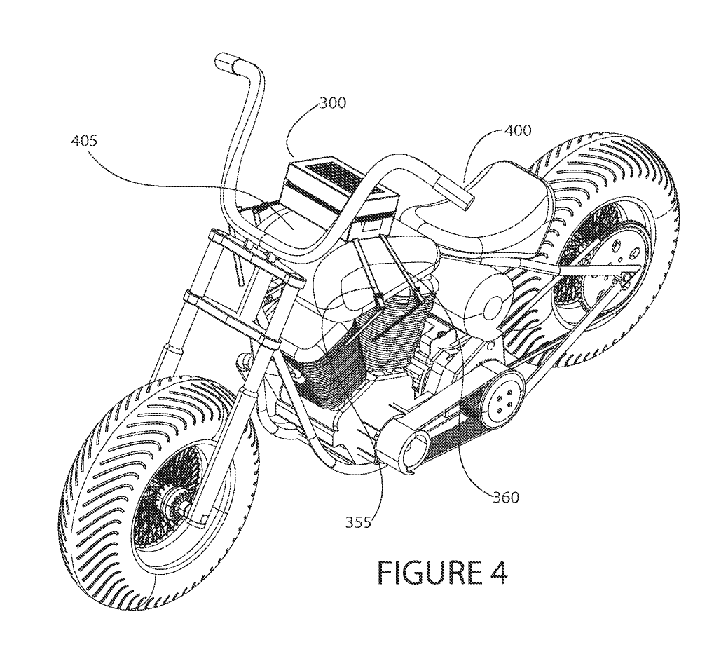

The system 100 is mounted to a motorcycle tank using a motorcycle tank bag. An exemplary motorcycle tank bag 300 is conceptually shown alone in FIG. 3 and positioned on a tank 405 of a motorcycle 400 in FIG. 4. The exemplary motorcycle tank bag 300 is a portable storage container that rests on top of a motorcycle fuel tank 405. The bag may be configured in many shapes and sizes sufficient to receive and store an exemplary audio amplifier system 100 according to principles of the invention. The bag may be constructed of a durable, flexible, textile material, such as a meshed material, preferably made from high-strength material, such as ultra high molecular weight polyethylene, nylon, polyester or para-aramid synthetic fibers. A rain cover, e.g., a shower cap style waterproof cover with an elastic band may be provided to shield the tank bag 300 and its contents from rain. In a preferred embodiment, the tank bag includes a top portion 305 hingedly attached to a bottom portion 315. A zipper 320 with a pull tab 325 or other closure releasably binds the top portion 305 and bottom portion 315 and allows access to the interior compartment of the tank bag 300. Various pockets may be provided on the inside and the outside of the tank bag for segregating various items. A handle and/or shoulder strap may be provided to allow for easy transport away from the motorcycle. A partially detachable side access panel 330 allows access to the interior compartment for the power supply plug 170 and any accessories 185 powered through the cigarette lighter outlet 160.

Advantageously, the top panel 310 of the tank bag 300 is perforated or a mesh configured to protect but ventilate and minimally obstruct the contained system 100. Sound emitted from the speakers 555, 560 freely propagates through the openings in the perforated and/or mesh top panel 310. The openings also facilitate ventilation, which can be important to reduce the buildup of heat by the amplifier 210. One or more openings in the top panel 310 may be configured to allow fingertip access to the volume and power controls of the system 100. Thus, a rider may conveniently adjust the system 100 while riding without the hassle and distraction of opening the tank bag 300.

Various mountings may be used to attach the tank bag 300 to the fuel tank of a motorcycle. For instance, the tank bag 300 may have magnetic mounting hardware (i.e., permanent magnets embedded in the bottom and/or flaps extending from the sides of the tank bag 300), which makes it easy to attach and detach from a motorcycle. However, not all motorcycle fuel tanks are steel. Some tanks are aluminum, composites or plastic. For these motorcycle tanks, a strap-on design is provided. The strap-on design includes a plurality of elongate flexible straps 345-360 equipped with interlocking male and female connectors 335, 340, 365, 370. Of course, the tank bag 300 may be equipped with both strap-on as well as magnetic attaching systems. The mounting straps 345-360 and connectors 335, 340, 365, 370 may be used to carry the tank bag as a backpack.

In an exemplary embodiment, the straps 345-360 are comprised of webbing, a strong fabric woven as a flat strip or tube. The fabric may be a meshed material, preferably made from high-strength material, such as ultra high molecular weight polyethylene, nylon, polyester or para-aramid synthetic fibers. For a less performance-oriented embodiment, cotton, polypropylene, or flax webbing may be used. Advantageously, webbing is both light and strong, and may be weather and abrasion resistant.

In an exemplary embodiment, each strap connector is a two-piece buckle assembly. Each exemplary connector 335, 340, 365, 370 includes a female receptacle 335, 340 configured to engage a corresponding male plug 365, 370. Each plug 365, 370 includes a centrally disposed guide bar and a pair of legs. When inserted into the receptacle 335, 340, the male plug 365, 370 snap fits into the receptacle. The connected pieces are unlocked and disengaged by squeezing the legs of the male plug 365, 370 allowing the two buckle pieces 110, 115 to become separated.

Skilled artisans will appreciate that the invention is not limited to the strap connectors described above. Other connectors capable of releasably attaching the straps may be utilized in addition to or in lieu of the connectors 335, 340, 365, 370 described above. Such other connectors may include for example center release buckles, threaded buckles, cam buckles, snap buckles, karabiners and spring clips. Such connectors may be used alone or as a backup or supplementary connector. Alternatively, the bag 300 may be equipped with magnets, in lieu of straps, to secure the bag to a fuel tank.

An exemplary cover 380 is illustrated in FIG. 3. The cover may protect the bag and its contents from the elements. The cover comprises a pliable bag like structure with an opening leading to a compartment. The compartment is sized to receive all or a substantial portion of the bag 300. The cover may include an elastic band, like a shower cap, or a cinch cord 390 and spring lock 385 to secure the cover 380 to the bag 300.

While use of an exemplary portable amplified audio system 100 for a motorcycle according to principles of the invention with a tank bag 300 is preferred, the tank bag 300 is not required. The exemplary portable amplified audio system 100 for a motorcycle may be removably attached to a tank without a tank bag. Elastic cords (e.g., bungee cords), straps and connectors as described above, permanent magnets and any combination of any of the aforementioned attachment means may be used to secure the system 100 to a tank without a tank bag 300. In the case of straps, the straps may be fastened to the cover 165 and/or base 150 of the system 100.

Referring now to the high level schematic of FIG. 5, the electronic components of an exemplary system include a battery 525 (i.e., a motorcycle battery) as a power supply. One or more fuses 520, 521, 522 or circuit breakers are provided to interrupt the flow of electrical current when the circuit or a component is overloaded or experiences a short. For example, the power inlet 155, outlet 160 and amplifier 210, may each be coupled to a fuse 520, 521, 522. A microcontroller 505 is configured to monitor battery voltage and control a relay 570. The microcontroller 505 and relay 570 together comprise a battery drain limitation circuit 225 configured to interrupt (i.e., block) electrical power supplied from the battery if the battery 525 voltage drops below a determined voltage (e.g., below 12 to 13 volts). If the battery 525 voltage equals or exceeds the determined voltage, the battery drain limitation circuit allows electrical power to be supplied from the battery to the loads, such as the amplifier 210, illuminated rocker switch 110 and power outlet 160. The amplifier 210 is an electronic audio amplifier that amplifies low-power audio signals emitted from the output port 125 of the portable audio device 130 through the connected audio interface jack 120 and cable 115, which is connected to an input port of the amplifier. The amplifier includes one or more output ports through which amplified signals may be supplied to one or more speakers 555, 560. The amplifier amplifies the low-power audio signals to a level suitable for driving speakers 555, 560 (FIG. 5), which are mounted to the cover 165 below protective speaker grilles 140, 145. The volume control knob 105 is operably coupled to potentiometers 545, 550 for each speaker 555, 560. Optionally, a wireless radio communication module such as a Bluetooth module 540 and corresponding microcontroller 565 configured to manage the receipt and transmission of radio signals may be provided to enable transmission to compatibly equipped wireless headsets and/or to receive audio signals from a compatibly equipped portable audio device 130.

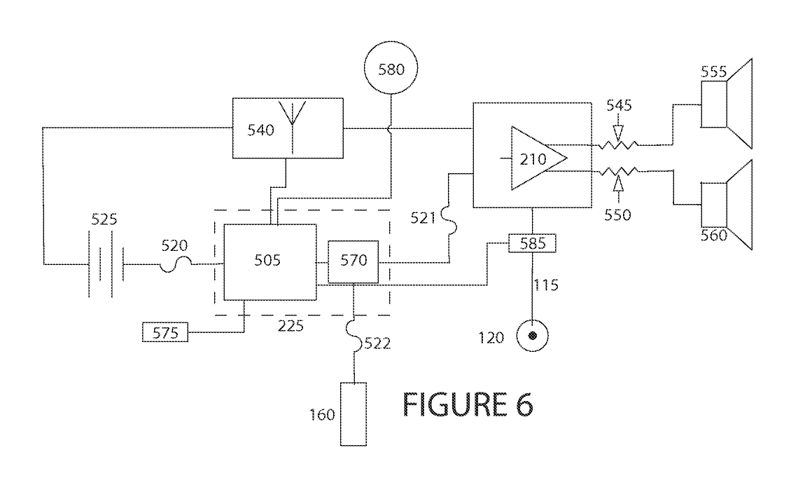

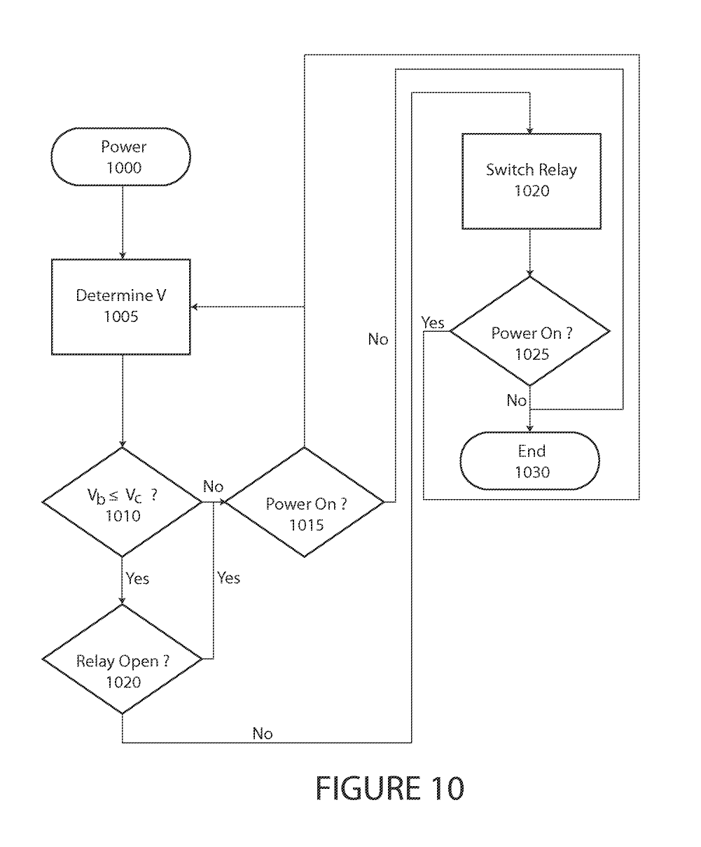

Referring now to the high level schematic of FIG. 6, the electronic components of an exemplary system include a battery 525 (i.e., a motorcycle battery) as a power supply. One or more fuses 520, 521, 522 or circuit breakers are provided to interrupt the flow of electrical current when the circuit or a component is overloaded or experiences a short. For example, the power supply 525, socket 160 and amplifier 210, may each be coupled to a fuse 520, 521, 522. A microcontroller 505 is configured to monitor battery voltage and control a relay 570. The microcontroller 505 and relay 570 together comprise a battery drain limitation circuit 225 configured to interrupt (i.e., block) electrical power supplied from the battery if the battery 525 voltage drops below a determined voltage (e.g., below 12 to 13 volts). A flowchart for a method of interrupting the power supply if such a drop in voltage is detected is provide in FIG. 10. If the battery 525 voltage equals or exceeds the determined voltage, the battery drain limitation circuit allows electrical power to be supplied from the battery to the loads, such as the amplifier 210, illuminated rocker switch 110 and power outlet 160. The amplifier includes one or more output ports through which amplified signals may be supplied to one or more speakers 555, 560. The amplifier amplifies the low-power audio signals to a level suitable for driving speakers 555, 560 (FIG. 5), which are mounted to the cover 165 below protective speaker grilles 140, 145. Optionally, a volume control knob 105 is operably coupled to potentiometers 545, 550 for each speaker 555, 560. In other embodiments, a volume control may be omitted because the volume controls on the portable electronic device may be utilized to adjust volume. Optionally, a wireless radio communication module such as a Bluetooth module 540 is operably coupled to the microcontroller 505 and configured to manage the receipt and transmission of radio signals to enable transmission to compatibly equipped wireless headsets and/or to receive audio signals from a compatibly equipped portable audio device 130.

Additionally, in this embodiment, an optional sensor (e.g., microphone) 580 is provided as a pressure transducer for measuring ambient noise. The measurement of sound pressure is based on the use of a microphone as a transducer to create a voltage signal that is proportional to (e.g., proportional to the root mean square) pressure at the point in space where the microphone is located. This voltage signal can be used to monitor the amplitude and frequency of these pressure variations that create the sensation of ambient sound. Analog signals from the sensor 580 are digitized using an A/D converter integrated with the microcontroller. Alternatively, a separate A/D converter may be included to effectuate the conversion. The result of the measurement may be expressed as the sound pressure level, measured in decibels (dB), relative to a reference level (e.g., 0 dB=2×10⁻⁵ Pascals). An average or weighted average of a series of pressure level measurements made over a period of time may be used. If that value is less than a determined threshold, e.g., 50 to 100 dB, then the ambient noise is low. If the ambient noise is low and the volume level is set high, the voltage (or current) of analog audio output sent to the amplifier may be reduced by redirecting the signals through a resistor 585 when a reduction in volume is desired, or by increasing resistance of a variable resistor. If the ambient noise is high and the volume level has been reduced, the voltage (or current) of analog audio output sent to the amplifier may be restored by redirecting the signals around the resistor 585 when no reduction in volume is desired, or by decreasing resistance of a variable resistor.

Alternatively, output from the electronic device through the audio interface jack 120 may be digitized and processed by the microcontroller 505, before being converted to an analog signal and sent to the amplifier 210. In such case, the microcontroller 505 regulates the output level. A switch may be provided to disable volume regulation when a high volume in a low noise environment is particularly preferred.

Advantageously, when the volume is regulated, the system may automatically lower the volume in quiet settings (e.g., at a stoplight without much wind or other ambient noise). The rider may comfortably hear the music without disturbing nearby motorists and pedestrians. When the motorcycle travels, wind, engine, exhaust and traffic noise may increase. When the ambient noise equals or exceeds a threshold, the volume is no longer reduced and returns to its original setting. This allows the rider to continue to hear the music even as ambient noise increases.

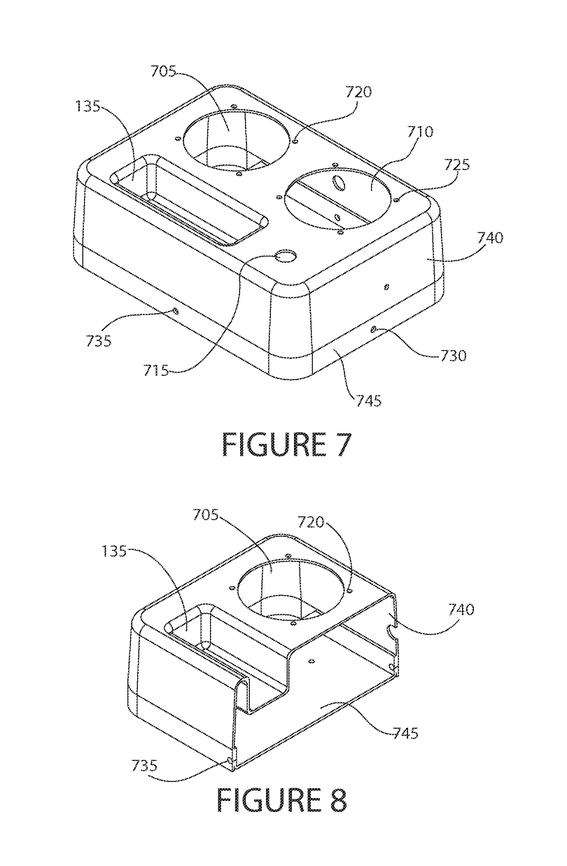

Referring now to FIG. 7 a perspective view of an exemplary molded housing for an exemplary portable amplified audio system for a motorcycle according to principles of the invention is conceptually illustrated. A section view of the molded housing is provided in FIG. 8. The housing includes a top cover 740 and a bottom cover 745. The top cover 740 includes speaker openings 705, 710, with corresponding holes 720, 725 for fasteners such as screws to secure speakers and grills to the housing. The top cover 740 also includes a switch opening 715 and openings for cords, such as a power cord and an audio jack. The top cover 740 includes a receptacle 135 for receiving a portable audio device 130. The receptacle 135 includes an open top to receive the portable audio device 130. The receptacle 135 is sized to receive a conventional portable audio player 130 or similarly configured electronic device. Holes 730, 735 in the top cover 740 and corresponding aligned holes in the bottom cover 745 are provided for fasteners (e.g., screws) to secure the top cover 740 to the bottom cover 745.

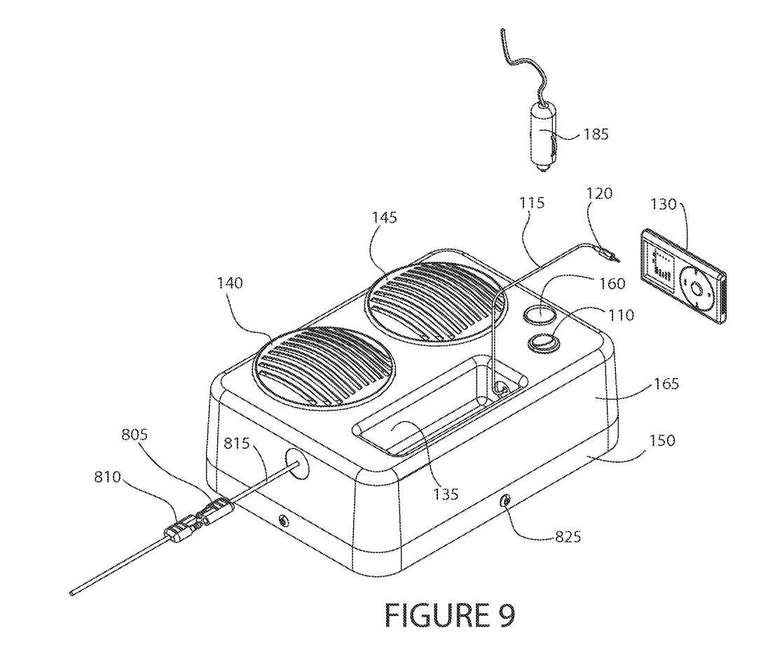

FIG. 9 is a perspective view of another portable amplified audio system 900 for a motorcycle according to principles of the invention. The top cover 740 includes a receptacle 135 for receiving a portable audio device 130. The portable audio device 130 may be placed in the receptacle 135. The receptacle 135 includes an open top to receive the portable audio device 130. The receptacle 135 is sized to receive a conventional portable audio player 130. An audio interface jack 120 operably connects the portable audio device 130 to the system 900 via a suitable electrical cord 115. In an exemplary embodiment, the portable audio device is a handheld digital media player 130 or any other suitable portable audio player device with a compatible output port 125. While a particular style jack 120 is conceptually shown for illustrative purposes, persons skilled in the art will appreciate that other types of jacks, including proprietary interfaces, may be utilized without departing from the scope of the invention. A system according to principles of the invention is compatible with most existing portable audio devices.

The assembled cover 740 and base 745 define an interior compartment that houses electronic components of the system 900. One or more screws 825 are provided to secure the top cover 740 to the bottom cover 745. Housed electronic components include an amplifier 210 and a battery isolator 225, and optionally a volume regulator. The amplifier is an electronic audio amplifier that amplifies low-power audio signals emitted from the output port 125 of the portable audio device 130 through the connected audio interface jack 120 and cable 115, which is connected to an input port of the amplifier. The amplifier includes one or more output ports through which amplified signals may be supplied to one or more speakers 555, 560. The amplifier amplifies the low-power audio signals to a level suitable for driving speakers 555, 560 (FIG. 5).

The system 900 receives electrical power from a motorcycle battery through a detachable electrical connection to facilitate installation and removal. In an exemplary embodiment, a polarized first connector 805 mates with a polarized second connector 810 operably coupled to an electrical cable 815 for electrically coupling to the positive and negative terminal terminals of the battery. When the wires are electrically coupled to a battery, electrical power is supplied to the system 900. The plug 805, 810 may include one or more magnets and/or clips for securing it to the motorcycle.

Electrical power is supplied to the amplifier 210 from the motorcycle battery, through a switch 820 electrically coupled to a battery isolator 225. In a preferred embodiment, the switch 820 is an illuminated on-off rocker switch 820 that controls the supply of electrical power to the battery isolator 225 and electrical components. The battery isolator 225 is a battery drain limitation circuit configured to monitor input voltage and interrupt (i.e., block) electrical power supplied from the battery if the battery voltage drops below a determined voltage. If the battery voltage equals or exceeds the determined voltage, the battery drain limitation circuit allows electrical power to be supplied from the battery to the system loads, such as the amplifier 210, illuminated rocker switch 820 and power outlet 160. Battery voltage may be monitored with a microcontroller or discrete circuit elements while isolation may be accomplished with a relay, a high current diode and/or a zener diode having a breakdown voltage below the determined minimum voltage. Thus, the battery isolator 225 disables the system 900 if necessary to prevent excessive draining of the battery.

A car cigarette lighter socket 160 or car adapter is provided. The socket 160 may be positioned on any surface of the top cover 740 with sufficient clearance behind the surface to accommodate the socket 160. The socket 160 provides a conduit for supplying electrical power to accessories through a compatible plug 185. Such sockets and mating plugs are defined in the ANSI/SAE J563 specification. By way of example and not limitation such plugs 185 may be used to supply power to electric razors, portable spotlights, laptop computers, mobile phones, PDAs, USB adapters, digital audio players, lamps, thermoelectric coolers and countless other compatible accessories. Compatible accessories with gooseneck supports may be plugged into and utilized using the socket 160.

The system 900 includes at least one audio loudspeaker (“speakers”), such as the pair of speakers 555, 560 preferably below protective speaker grilles 140, 145, as conceptually illustrated in the FIGS. 1, 2 and 5. The speakers 555, 560 are conventional audio speakers configured to emit audible sounds in response to input electronic signals. In a preferred embodiment, weather resistant speakers are used; although the invention is not limited to such speakers. The speakers 555, 560 project the sound to the rider. Optionally, the speakers may be actively controlled with an electronic processor that automatically adjusts crossover and equalization settings and protects the speakers. The speakers 555, 560 have a power rating (in watts) which is compatible with that of the amplifier 210.

In this particular embodiment, no additional volume control knob is provided on the system. To regulate the volume of audible output from the speakers 555, 560, the volume control on the electronic device 130 may be utilized.

The system 900 is mounted to a motorcycle tank using a motorcycle tank bag. An exemplary motorcycle tank bag 300 is conceptually shown alone in FIG. 3 and positioned on a tank 405 of a motorcycle 400 in FIG. 4. The exemplary tank bag features a porous cover 310. However, any tank bag capable of holding the system 900 may be utilized to secure the system to a motorcycle. By way of example and not limitation, the tank bag typically includes a zippered pliable front (top) flap that may be opened and folded into the compartment of the bag. With such bags, the system 900 may be placed on top of the folded flap in the compartment. Alternatively, the flap may be opened and folded to avoid blocking the speakers. As another alternative, the flap may be removed from the tank bag.

Referring now to FIG. 10, a flowchart of an exemplary method of preventing excessive drain on a battery according to principles of the invention is shown. In one embodiment, the system 100 includes a battery drain limitation circuit. Components of the circuit include a microcontroller configured to monitor battery voltage and a relay operably coupled to the microcontroller and configured to interrupt electrical power supplied from the battery if the battery voltage drops below a determined voltage. When the system is powered on, as in step 1000, the battery voltage, V_{b}, is determined, as in step 1005. If the battery voltage exceeds a cutoff voltage, V_{c}, then so long as the power remains on, as determined in step 1015, the system will continue to monitor battery voltage as in step 1005. If the battery voltage equals or is less than a cutoff voltage, V_{c}, (i.e., a low voltage event) a determination is made if the relay is open, as in step 1020. If the relay is already open (i.e., the circuit is broken), as determined in step 1020, there is no need to switch the relay. However, if the relay is closed and a low voltage event occurs, then the relay is switched open, as in step 1020. Even with the relay open, the system will continue to monitor battery voltage, so long as the system is powered on, as determined in step 1025. When the system is powered down, the process ends, as in step 1030.

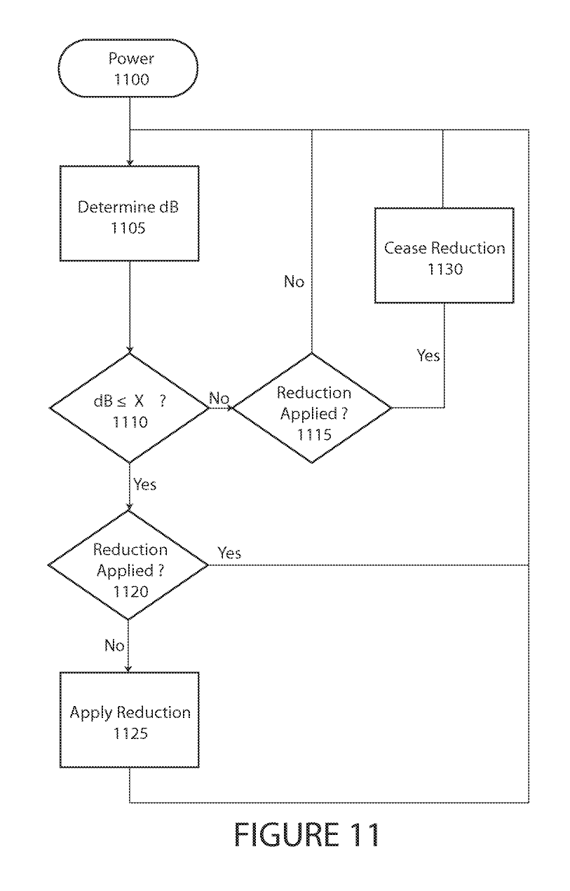

Referring now to FIG. 11, a flowchart of an exemplary method of preventing excessive volume according to principles of the invention according to principles of the invention is shown. The method entails powering up the system in step 1100. Then the ambient noise is measured, such as in decibels, as in step 1105. Then the measured noise values are compared with a determined threshold value, as in step 1110. If the measured noise exceeds the threshold, then the ambient noise is loud. If the measured noise is less than the threshold, then the ambient noise is not loud. If low noise is determined, then, if the volume has not already been reduced as determined in step 1120, the volume is reduced, as in step 1125. If loud noise is determined and the volume has already been reduced as determined in step 1115, then the reduction ceases in step 1130. If loud noise is determined and the volume has not already been reduced as determined in step 1115, then control passes to step 1105. In each case, control returns to step 1105, allowing the noise to continuously or repeatedly be measured. Volume is reduced and reduction ceases in response to low or high noise detections.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A portable amplified audio system for a motorcycle having a battery, said system comprising
a housing having an open receptacle comprising a compartment in the housing with an open top for receiving and supporting a portable audio device,
an audio amplifier contained in the housing, said audio amplifier having an audio input interface, an audio output interface and a power supply interface,
a device interface configured to connect to the portable audio device and communicate audio output signals from said portable audio device to the audio input interface of the amplifier, said amplifier being configured to generate amplified audio output signals from said audio output signals from said portable audio device,
at least one loudspeaker attached to the housing and operably coupled to the audio output interface of the amplifier, and configured to receive amplified audio output signals from the amplifier through the output interface and produce audible sounds based upon said amplified audio output signals,
an electric power inlet configured to receive electrical power from the battery, and
a motorcycle tank bag,
said housing being contained within the motorcycle tank bag.

2. A portable amplified audio system according to claim 1, said system further comprising a battery drain limitation circuit electrically coupled to said electric power inlet and configured to monitor voltage and interrupt electrical power supplied from the battery through the electric power inlet if the battery voltage drops below a determined voltage.

3. A portable amplified audio system according to claim 1, said system further comprising a battery drain limitation circuit electrically coupled to said electric power inlet, said battery drain limitation circuit comprising a microcontroller configured to monitor battery voltage and further comprising a relay operably coupled to said microcontroller and configured to interrupt electrical power supplied from the battery through the electric power inlet if the battery voltage drops below a determined voltage.

4. A portable amplified audio system according to claim 1, said system further comprising a volume regulation circuit electrically coupled to said electric power inlet, said circuit comprising a sound sensor configured to produce analog signals corresponding to detected sound, an analog to digital converter configured to produce digital signals based upon the analog signals, a microcontroller configured to determine a measured sound value from the digital signals and further configured to compare the measured sound value with a determined value, a volume regulator configured to reduce the volume of sound output through the loudspeakers if the measured sound value is less than the determined value.

5. A portable amplified audio system according to claim 4, said analog to digital converter comprising an integral component of the microcontroller.

6. A portable amplified audio system according to claim 4, said volume regulator comprising a resistor.

7. A portable amplified audio system according to claim 4, said volume regulator comprising a digital to analog converter.

8. A portable amplified audio system according to claim 1, said system further comprising a power switch mounted to said housing and electrically coupled between said electric power inlet and said amplifier and configured to control electrical power supplied from the electric power inlet.

9. A portable amplified audio system according to claim 1, said system further comprising a volume controller mounted to said housing, operably coupled to each loudspeaker and configured to adjust the volume of each loudspeaker.

10. A portable amplified audio system according to claim 1, said housing comprising a removable cover attached to a base.

11. A portable amplified audio system according to claim 1, said system further comprising a power outlet configured to supply electrical power to a compatible plug.

12. A portable amplified audio system according to claim 1, said system further comprising a polarized electric plug adapted to removably mate with said electric power inlet, and a power cable comprising a pair of electrically conductive wires operably coupled to said plug and to terminals of the battery of the motorcycle.

13. A portable amplified audio system according to claim 1, said system further comprising a polarized electric plug with a positive and negative terminal adapted to removably mate with said electric power inlet, and a power cable comprising a pair of electrically conductive wires operably coupled to said plug and to terminals of the battery of the motorcycle, said system further including a removable plug cover configured to cover the positive and negative terminals of the polarized electric plug, said plug cover being tethered to the system.

14. A portable amplified audio system according to claim 1, said system further comprising a polarized electric plug with a positive and negative terminal adapted to removably mate with said electric power inlet, and a power cable comprising a pair of electrically conductive wires operably coupled to said plug and to terminals of the battery of the motorcycle, said system further including a removable plug cover configured to plug cover the positive and negative terminals of the polarized electric plug, said plug cover being tethered to the system, and said plug cover including a permanent magnet configured to releasably connect the plug cover to an adjacent attracted metal component of the motorcycle.

15. A portable amplified audio system according to claim 1, wherein each loudspeaker is weather resistant.

16. A portable amplified audio system according to claim 1, further comprising a radio communication module configured to communicate output signals from said portable audio device to a compatible wireless headset.

17. A portable amplified audio system according to claim 1, said motorcycle tank bag comprising a top panel with openings in alignment with each loudspeaker and through which sound may be transmitted from each loudspeaker.

18. A portable amplified audio system according to claim 1, said motorcycle tank bag further comprising a removable weatherproof cover.

19. A portable amplified audio system according to claim 1, said housing having a power switch and said motorcycle tank bag comprising a top panel with an opening in alignment with the power switch and through which the power switch is exposed.

20. A portable amplified audio system according to claim 1, said motorcycle tank bag further comprising a side access panel configured to allow passage of a power cable to supply electrical power to the system.
